(19) United States
(12) Patent Application Publication
(10) Pub. No.: US 2002/0029334 A1
(43) Pub. Date: Mar. 7, 2002

(54) High availability shared memory system

(76) Inventors: Karlon K. West, Austin, TX (US); Lynn P. West, Austin, TX (US)

Correspondence Address: John J. Bruckner, Fulbright & Jaworski L.L.P., Suite 2400, 600 Congress Avenue, Austin, TX, 78701, US

(21) Appl. No.: 09/912,856

(22) Filed: Jul. 25, 2001

Related U.S. Application Data
(60) Provisional application No. 60/220,974, filed on Jul. 26, 2000.
(60) Provisional application No. 60/220,748, filed on Jul. 26, 2000.

(51) Int. Cl. G06F 9/00; G06F 9/24

(52) U.S. Cl. 713/2

(57) ABSTRACT

Systems and methods are described for a high availability shared memory system. A method includes A method, comprising: receiving an instruction to execute a system boot operation; executing the system boot operation using data resident in a primary shared memory node; and initializing a secondary shared memory node upon completion of the system boot operation. A method, includes accessing a primary shared memory node; executing software processes in a processing node; duplicating events occurring in the primary shared memory node in a secondary shared memory node; monitoring communication between the processing node and the primary shared memory node to recognize an error in communication between the processing node and the primary shared memory node; monitoring events occurring in the primary shared memory node to recognize an error in the events occurring in the primary shared memory node; if an error is recognized, writing a FAILED code to the primary shared memory node and designating the primary shared memory node as failed; and if an error is recognized, switching system operation to the secondary shared memory node. An apparatus includes *a processing node; a dual-port adapter coupled to the processing node; a primary shared memory node coupled to the dual-port adapter; and a secondary shared memory node coupled to the dual-port adapter.

### CROSS-REFERENCES TO RELATED APPLICATIONS

This application is a continuation-in-part of, and claims a benefit of priority under 35 U.S.C. 119(e) and/or 35 U.S.C. 120 from, copending U.S. Ser. No. 60/220,974, filed Jul. 26, 2000, and 60/220,748, also filed Jul. 26, 2000, the entire contents of both of which are hereby expressly incorporated by reference for all purposes.

### BACKGROUND OF THE INVENTION

1. Field of the Invention

The invention relates generally to the field of multiprocessor computer systems. More particularly, the invention relates to parallel processing systems in which one or more processors have unrestricted access to one or more shared memory units.

2. Discussion of the Related Art

Shared memory systems and message-passing systems are two basic types of parallel processing systems. Shared memory parallel processing systems share data by allowing processors unrestricted access to a common memory which can be shared by some or all of the processors in the system. In this type of parallel processing system, it is necessary for processors to share memory. As a result being able to share memory among processors, data can be passed to all processors in such a system with high efficiency by allowing the processors to access the shared memory address that houses the requested data. Message-passing parallel processing systems share data by passing messages from processor to processor. In this type of parallel processing system, processors do not share any resources. Each processor in the system is capable of functioning independently of the rest of the system. In this type of system, data cannot be passed to multiple processors efficiently. Applications are difficult to program for such systems because of the added complexities introduced when passing data from processor to processor.

Message-passing parallel processor systems have been offered commercially for years but are not widely used because of poor performance and difficulty of programming for typical parallel applications. However, message-passing parallel processor systems do have some advantages. In particular, because they share no resources, message-passing parallel processor systems are easy to equip with high-availability, low failure rate features.

Shared memory systems, however, have been much more successful because of dramatically superior performance, up to about four-processor systems. However, providing high availability and low failure rates for traditional shared memory systems has proved difficult thus far. Because system resources are shared in such systems, it can be anticipated that failure of a shared system resource will likely result in a total system failure. The nature of these systems is incompatible with resource separation that is typically required for high availability low failure rate systems.

Heretofore, the combined requirements of high performance, high-availability, and low failure rates in a parallel processing system as referred to above has not been fully met. What is needed is a solution that addresses these requirements.

### SUMMARY OF THE INVENTION

There is a need for the following embodiments. Of course, the invention is not limited to these embodiments.

According to a first aspect of the invention, a method comprises: receiving an instruction to execute a system boot operation; executing the system boot operation using data resident in a primary shared memory node; and initializing a secondary shared memory node upon completion of the system boot operation. According to a second aspect of the invention, a method, comprises: accessing a primary shared memory node; executing software processes in a processing node; duplicating events occurring in the primary shared memory node in a secondary shared memory node; monitoring communication between the processing node and the primary shared memory node to recognize an error in communication between the processing node and the primary shared memory node; monitoring events occurring in the primary shared memory node to recognize an error in the events occurring in the primary shared memory node; if an error is recognized, writing a FAILED code to the primary shared memory node and designating the primary shared memory node as failed; and if an error is recognized, switching system operation to the secondary shared memory node. According to a third aspect of the invention, an apparatus comprises: a processing node; a dual-port adapter coupled to the processing node; a primary shared memory node coupled to the dual-port adapter; and a secondary shared memory node coupled to the dual-port adapter.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a block diagram of a parallel processing system, representing an embodiment of the invention.

FIG. 2 illustrates a block diagram of a highly available parallel processing system, representing an embodiment of the invention.

FIG. 3 illustrates a dual port adapter, representing an embodiment of the invention.

FIG. 4 illustrates a shared memory parallel processing unit, representing an embodiment of the invention.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known components and processing techniques are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this detailed description.

The below-referenced U.S. patent applications disclose embodiments that were satisfactory for the purposes for which they are intended. The entire contents of U.S. Ser. Nos. 09/273,430, filed Mar. 19, 1999; 09/859,193, filed May 15, 2001; 09/854,351, filed May 10, 2001; 09/672,909, filed Sep. 28, 2000; 09/653,189, filed Aug. 31, 2000; 09/652,815, filed Aug. 31, 2000; 09/653,183, filed Aug. 31, 2000; 09/653,425, filed Aug. 31, 2000; 09/653,421, filed Aug. 31, 2000; 09/653,557, filed Aug. 31, 2000; 09/653,475, filed Aug. 31, 2000; 09/653,429, filed Aug. 31, 2000; 09/653,502, filed Aug. 31, 2000; ______ (Attorney Docket No. TNSY:017US), filed Jul. 25, 2001; ______ (Attorney Docket No. TNSY:018US), filed Jul. 25, 2001; ______ (Attorney Docket No. TNSY:019US), filed Jul. 25, 2001; ______ (Attorney Docket No. TNSY:020US), filed Jul. 25, 2001; ______ (Attorney Docket No. TNSY:022US), filed Jul. 25, 2001; ______ (Attorney Docket No. TNSY:023US), filed Jul. 25, 2001; ______; ______ (Attorney Docket No. TNSY:024US), filed Jul. 25, 2001; and ______ (Attorney Docket No. TNSY:026US), filed Jul. 25, 2001 are hereby expressly incorporated by reference herein for all purposes.

The context of the invention can include high speed parallel processing situations, such as Ethernet, local area networks, wireless networks including IEEE 802.11 and CDMA networks, local data loops, and in virtually any and every situation employing parallel processing techniques.

Shared memory systems of the type described in U.S. patent application Ser. No. 09/273,430 are quite amenable to high-availability low failure rate design. In a system of this type, each processing node is provided with a full set of privately-owned facilities, including processor, memory, and I/O devices. Therefore, only the most critical of failures can cause total system failure. Only elements of absolute necessity are shared in such a system. Shared resources in such a system include a portion of memory and mechanisms to assure coordinated processing of shared tasks.

The invention discloses a high-availability low failure rate parallel processing system in which failure of any single shared memory node can be overcome without causing system failure. The shared elements in such a parallel processing system include a memory and an atomic memory in which a load to a particular location causes not only a load of that location but also a store to that location. These shared facilities can be prevented from causing system failure if they are duplicated, and if each load or store to a shared facility is passed to each node of the corresponding shared facility duplicate pair. A first copy of a shared facility is designated as a primary shared memory node, and a corresponding duplicate shared facility is designated as a secondary shared memory node. Thus, if a primary shared memory node of one of the duplicate pairs fails, the secondary shared memory node has all of the state information that resided in the failed shared memory node and thus a switch-over to the backup shared memory node allows normal system operation to continue unaffected, despite failure of a shared memory node.

The invention further discloses methods and apparatus for combining the features of a high-availability low failure rate shared memory system with a load distributing capability. The methods described herein include the use of a second shared-memory node (SMN) for performance enhancement, and the use of multiple SMNs to provide high availability, low failure rates, and performance enhancement for a given shared-memory system. The invention includes a system which can recover from any single point of failure. The techniques taught herein will also provide recovery for certain multiple simultaneous failures, but is not a general solution for multiple simultaneous failures in shared memory parallel processing systems.

Switchover of operation from a primary shared memory node to a secondary shared memory node in the event of failure is taught by the invention. It should be obvious to one skilled in the art that numerous variations to the techniques described here are possible and do not avoid the teachings of the invention.

For performance enhancement to be successful, several elements are required. First, each processing node must be provided with connectivity to at least two SMNs. Second, SMNs must be denoted as primary and secondary, because there are certain functions which occur at boot time which must be managed using a single common point of communication. Third, the data which is accessed from either one of the SMNs must be in a separate address range from the data accessed from the other shared node.

The invention facilitates from either of two single failures: failure of a single element of the interconnect between any given processing node and a shared memory node, or failure of one of the two SMNs in a shared memory parallel processing system of the type described by Scardamalia et al U.S. Ser. Nos. 09/273,430, filed Mar. 19, 1999.

In an embodiment of the invention, a shared memory parallel processing system includes a primary SMN which features an atomic complex and a “doorbell” signaling mechanism via which processing nodes may signal each other. The hardware subsystem of such a shared memory parallel processing system can consist of processing nodes, each of which include PCI adapters that contain significant intelligence in hardware and a connection mechanism between each of the PCI adapters in the processing nodes and a corresponding set of PCI adapters in a primary SMN. Each processing node is also provided with a second PCI adapter or with a second channel out of a single PCI adapter. The second channel or second PCI adapter is provided with a further connection mechanism to a secondary SMN. The hardware subsystem passes information between the numerous processing nodes and the SMNs. The hardware subsystem also includes apparatus and methods to differentiate between primary and secondary SMNs. Boot operations are passed only to the primary SMNs.

The primary SMN is configured in the processing nodes to occupy a first shared-memory range and the atomic complex, whereas the secondary SMN is configured in the processing node to be accessible only by a second shared memory range.

For either case (one dual-connection PCI adapter or two separate adapters) software at the processing node re-programs the hardware to fully activate the secondary connection when the primary connection has been used to fully boot the system.

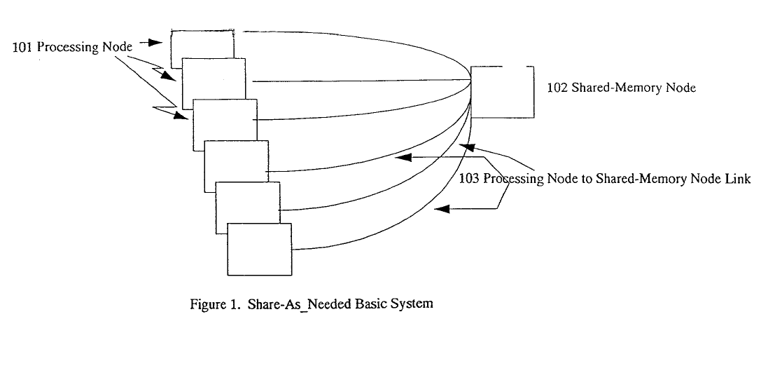

Referring to FIG. 1, a basic share-as-needed system is shown. In FIG. 1, a computer system with only one shared memory node 102 is shown. The shared memory unit 102 is coupled to a plurality of processing nodes 101 via a corresponding plurality of links 103. The plurality of links 103 may selected from a group consisting of, but not limited to, bus links, optical signal carriers, or hardwire connections, such as via copper cables. Each of the plurality of processing nodes 101 has total access to data stored in the shared memory node 102.

FIG. 1 is a drawing of an overall share-as-needed system, showing multiple processor nodes, a single SMN, and individual connections between the processing nodes and the SMN.

Still referring to FIG. 1, element 101 shows the processing nodes in the system. There can be multiple such nodes, as shown. Element 102 shows the SMN for the system of FIG. 1, and element 103 shows the links from the various processing nodes to the single shared-memory node.

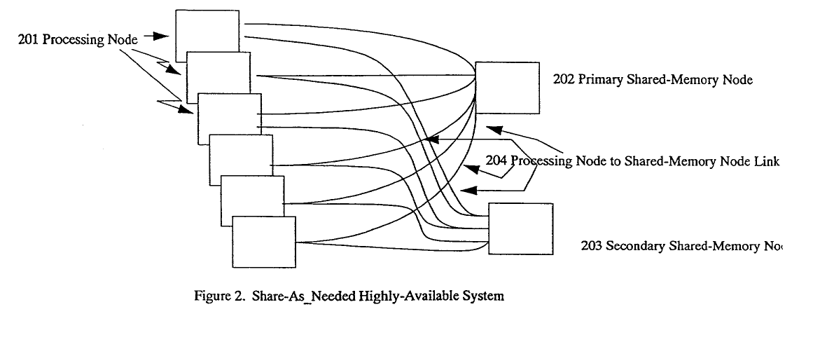

FIG. 2 illustrates a system having multiple processor nodes, two SMNs, and a connection media linking each processing node to both SMNs.

Referring to FIG. 2, a share-as-needed highly available system is shown. A first primary shared-memory node 202 is coupled to each of N (where N≧2) processing nodes 201 via N corresponding connection links 204. The connection links 204 can be selected from a group including, but not limited to, optical signal carriers, hardwire connections such as copper conductors, and wireless signal carriers. A first secondary shared-memory node 203 is also coupled to each of N (where N≧2) processing nodes 201 via N corresponding connection links 204.

Still referring to FIG. 2, element 201 represents the processing nodes in the system. There can be multiple such nodes, as shown. Element 202 shows the primary SMN for the system of FIG. 2, and element 203 is the secondary SMN. Element 204 shows the links from the various processing nodes to both the primary and secondary SMNs.

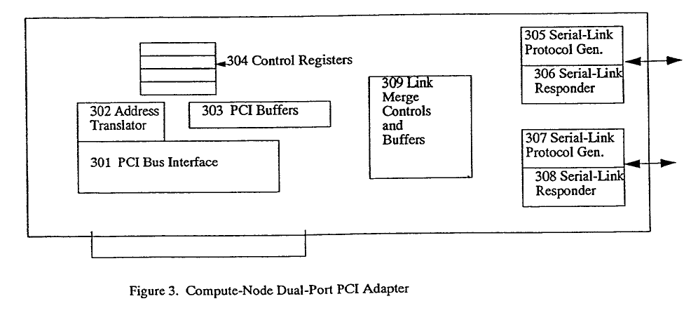

FIG. 3 shows a drawing of a PCI adapter at a processing node, showing multiple link interfaces to the multiple SMNs.

With reference to FIG. 3, element 301 shows the PCI Bus interface logic, and element 302 shows the address translator which determines whether a PCI Read or Write command is intended for shared memory. Element 303 represents the data buffers used for passing data to and from the PCI interface, and element 304 depicts the various control registers required to manage the operation of a PCI adapter. Elements 305 and 307 are the send-side interfaces to the primary and secondary shared memory units respectively, and elements 306 and 308 are the corresponding receive-side interfaces to the shared memory units.

Element 309 directs the PCI Read and Write commands to elements 305 and 307. In addition, element 309 accepts the results of those commands from elements 306 and 308. During normal operation, element 309 performs these functions. First, for PCI Read commands to the first range of shared addresses, it accesses the primary SMN and accepts the result from the primary SMN. For PCI Write commands to the first range of shared addresses, element 309 transfers those commands to the first SMN and accepts acknowledgements from it. For atomic PCI Read commands, element 309 accesses the primary SMN. For PCI commands to the second range of SMN addresses, element 309 transfers those commands to the secondary SMN, and handles associated data as above.

When notified by software to switch to the secondary SMN, the adapter of FIG. 3, through element 309, abandons operations to the primary SMN and begins operations to the secondary SMN.

During the course of the normal operation of the system, element 309 within the PCI adapter (of FIG. 3) of each processing node continually controls and monitors the redundant element pairs 305 and 306 being one pair and 307 and 308 being the other. Should a write packet or read packet be sent to either SMN through the pair connected to that SMN fail to be successfully acknowledged after a programmable-set number of retries, element 309 sets a register in 304 informing the software in the processing node that the particular SMN has failed. Similarly, element 309 counts the ratio of CRC errors to packets from each SMN. Should the count exceed a programmable threshold value, element 309 sets a register in 304 informing the software in the processing node that the particular SMN has failed.

Within the processing node, a maintenance heartbeat is also regularly used to read a fully-shared known location within the SMNs. Since all writes go to both SMNs, this value will be identical in both SMNs. Should the register in 304 of any processing node indicate that a particular SMN or link to that SMN has failed, the maintenance heartbeat will write a “FAILED” code to the fully-shared known SMN location. Thus the good SMN with the good link thereto will then contain this code in the given location. In addition, the failure condition is made available to the operator/maintenance function within that processing node so that repair action can begin. Also in addition, each processing node is provided with a private-write, shared-read known location within the SMN. When the fully-shared location is written with the FAILED code, the shared-read location then writes the same FAILED code to the private-write SMN location of the particular processing node on which it is running. At that point, the maintenance software writes a code to a control register in 304 so that the control unit 309 no longer sends Read Packets to the SMN marked as FAILED.

That particular instantiation of the maintenance heartbeat, when it subsequently reads the fully-shared known location, the reads the private-write, shared-read known locations for the other processing nodes. When they are all marked FAILED, the processing node no longer sends Write Packets to the FAILED SMN.

It should be obvious to one skilled in the art that the above process could be done using two different adapters in each processing node. It should also be obvious to one skilled in the art that the primary SMN can provide the result of an atomic Read to the secondary SMN.

In another embodiment of the invention, there could be a third shared SMN. The third SMN would behave much like the secondary SMN, duplicating all of the events in the primary and/or secondary SMNs. For instance, if the primary SMN were to fail, the third SMN could then be the backup to the secondary SMN which would now be responsible for system operation. The third SMN could continue to duplicate all of the events occurring in the secondary SMN. If the secondary SMN were to fail, the third SMN would either take over the role of backup to the primary SMN or, if the primary SMN has already failed, become responsible for system operation. The benefit of the addition of the third SMN is to allow the system to handle two shared memory node failures without complete system failure instead of just one.

Another embodiment of the invention could include a fourth SMN acting in an analogous relationship with the third SMN as the third SMN with the secondary one. A fourth SMN would allow the system to handle three SMN failures without complete system failure. An almost unlimited number of SMNs could be added in an analogous manner to achieve the desired balance of low failure rate and system resource use.

In another preferred embodiment of the invention, each of the described SMNs are provided with a fully-mirrored backup, and the processing nodes are provided with a separate connection to each of the SMNs.

In another embodiment of the invention, only two SMNs are provided. Each is provided with the atomic complex, and with a mirrored range of addresses. For the atomic range of addresses and for the mirrored address range, element 309 operates as described in U.S. Ser. No. 09/273,430, filed Mar. 19, 1999, whereas for the remainder of the shared memory ranges, element 309 operates as described above. In this way the system can be combined with a logging application which logs completed results into the mirrored address range, and the resulting system will have the advantages of load distribution for performance along with high availability and low failure rates.

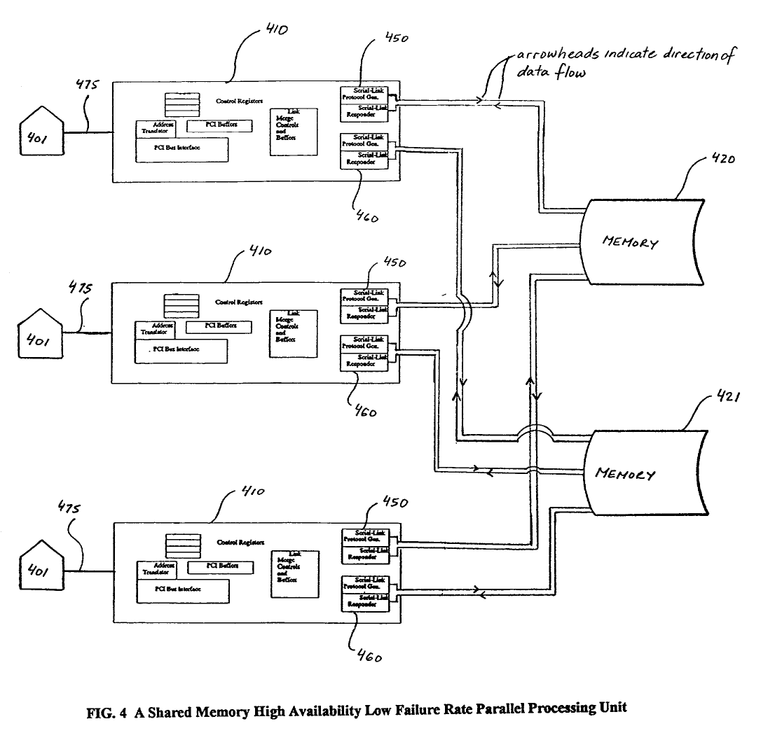

Referring to FIG. 4, a shared memory high availability low failure rate parallel processing unit is shown. Processing nodes 401 are each coupled to a dual-port PCI adapter 410 via buses 475. Each dual-port PCI adapter 410 is coupled to both a primary shared memory node 420 and a secondary shared memory node 421. The dual-port PCI adapters 410 are coupled to the primary shared memory node 420 via a primary shared memory interface 450 located within each dual-port PCI adapter 410. The dual-port PCI adapters 410 are coupled to the secondary shared memory node 421 via a secondary shared memory interface 460 located within each dual-port PCI adapter 410. Both the primary shared memory interface 450 and the secondary shared memory interface 460 located on each dual-port PCI adapter 410 are bi-directional (the direction of data flow to and from each interface is indicated in FIG. 4).

The invention can also be included in a kit. The kit can include some, or all, of the components that compose the invention. The kit can be an in-the-field retrofit kit to improve existing systems that are capable of incorporating the invention. The kit can include software, firmware and/or hardware for carrying out the invention. The kit can also contain instructions for practicing the invention. Unless otherwise specified, the components, software, firmware, hardware and/or instructions of the kit can be the same as those used in the invention.

The phrase “events occurring” in a given memory node, as used herein, refers to changes in memory including, but not limited to, loads, stores, refreshes, allocations, and deallocations in and to the memory node. In the context of events occurring, the term communicating can be defined as duplicating, which can include copying, which, in turn, can include mirroring.

The term approximately, as used herein, is defined as at least close to a given value (e.g., preferably within 10% of, more preferably within 1% of, and most preferably within 0.1% of). The term substantially, as used herein, is defined as at least approaching a given state (e.g., preferably within 10% of, more preferably within 1% of, and most preferably within 0.1% of). The term coupled, as used herein, is defined as connected, although not necessarily directly, and not necessarily mechanically. The term deploying, as used herein, is defined as designing, building, shipping, installing and/or operating. The term means, as used herein, is defined as hardware, firmware and/or software for achieving a result. The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The terms including and/or having, as used herein, are defined as comprising (i.e., open language). The terms a or an, as used herein, are defined as one or more than one. The term another, as used herein, is defined as at least a second or more.

While not being limited to any particular performance indicator or diagnostic identifier, preferred embodiments of the invention can be identified one at a time by testing for the absence of process failures. The test for the absence of process failures can be carried out without undue experimentation by the use of a simple and conventional memory access experiment.

### Practical Applications of the Invention

A practical application of the invention that has value within the technological arts is in secure electronic data transfer applications requiring exceptionally low system failure rates. Further, the invention is useful in conjunction with computer networking devices (such as are used for the purpose of Internet servers), or the like. There are virtually innumerable uses for the invention, all of which need not be detailed here.

### Advantages of the Invention

A high-availability, load distributing shared-memory computing system, representing an embodiment of the invention, can be cost effective and advantageous for at least the following reasons. The invention greatly increases overall computer system performance, reduces system failure rates, and allows for load-distributing capabilities while simultaneously reducing the need for dedicated private resources. The invention improves quality and/or reduces costs compared to previous approaches.

All the disclosed embodiments of the invention disclosed herein can be made and used without undue experimentation in light of the disclosure. Although the best mode of carrying out the invention contemplated by the inventor(s) is disclosed, practice of the invention is not limited thereto. Accordingly, it will be appreciated by those skilled in the art that the invention may be practiced otherwise than as specifically described herein.

Further, the individual components need not be formed in the disclosed shapes, or combined in the disclosed configurations, but could be provided in virtually any shapes, and/or combined in virtually any configuration. Further, the individual components need not be fabricated from the disclosed materials, but could be fabricated from virtually any suitable materials.

Further, variation may be made in the steps or in the sequence of steps composing methods described herein.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
receiving an instruction to execute a system boot operation;
executing the system boot operation using data resident in a primary shared memory node; and
initializing a secondary shared memory node upon completion of the system boot operation.

2. The method of claim 1, wherein the instruction to execute a system boot operation is received from software by a processing node.

3. The method of claim 1, wherein the secondary shared memory node is in a standby status after initialization.

4. The method of claim 1, further comprising initializing a third shared memory node upon completion of the system boot operation.

5. The method of claim 4, further comprising initializing a fourth shared memory node upon completion of the system boot operation.

6. A method, comprising:
accessing a primary shared memory node;
executing software processes in a processing node;
duplicating events occurring in the primary shared memory node in a secondary shared memory node;
monitoring communication between the processing node and the primary shared memory node to recognize an error in communication between the processing node and the primary shared memory node;
monitoring events occurring in the primary shared memory node to recognize an error in the events occurring in the primary shared memory node;
if an error is recognized, writing a FAILED code to the primary shared memory node and designating the primary shared memory node as failed; and
if an error is recognized, switching system operation to the secondary shared memory node.

7. The method of claim 6, further comprising: if an error has been recognized, retrying at least one member selected from the group consisting of monitoring communication between the processing node and the primary shared memory node and monitoring events occurring in the primary shared memory node.

8. The method of claim 7, wherein retrying is repeated a programmable number of times.

9. The method of claim 6, further comprising:
if an error has been recognized,
abandoning operation of the failed primary shared memory node once a FAILED code is written to it;
writing a copy of the FAILED code to the secondary shared memory node; and
writing a copy of the FAILED code to a shared memory node repair register.

10. The method of claim 9, further comprising: restoring system operation to a repaired primary shared memory node; and reinitializing the secondary shared memory node.

11. The method of claim 6, wherein switching system operation to the secondary shared memory node includes providing the processing node with unrestricted access to the secondary shared memory node.

12. The method of claim 6, further comprising:
monitoring communication between the processing node and the secondary shared memory node to recognize an error in the events occurring in the secondary shared memory node;
monitoring events occurring in the secondary shared memory node to recognize an error in the events occurring in the secondary shared memory node.

13. The method of claim 6, further comprising:
duplicating events occurring in the memory node responsible for system operation in a third memory node;
monitoring communications between the processing node and the third shared memory node to recognize an error in the events occurring in the third shared memory node;
monitoring events occurring in the third shared memory node to recognize an error in the events occurring in the secondary shared memory node.

14. The method of claim 13, further comprising:
duplicating events occurring in the memory node responsible for system operation in a fourth memory node;
monitoring communications between the processing node and the fourth shared memory node to recognize an error in the events occurring in the fourth shared memory node;
monitoring events occurring in the fourth shared memory node to recognize an error in the events occurring in the secondary shared memory node.

15. The method of claim 12, further comprising:
if an error is recognized in the secondary shared memory node, writing a FAILED code to the secondary shared memory node and designating the secondary shared memory node as failed.

16. The method of claim 15, further comprising:
if an error is recognized in the secondary shared memory node, switching backup of the primary shared memory node to a third shared memory node.

17. The method of claim 12, further comprising:
if an error is recognized in the secondary shared memory node, attempting to copy events occurring in the primary shared memory node to the secondary shared memory node.

18. The method of claim 13, further comprising:
if an error is recognized in the third shared memory node, writing a FAILED code to the third shared memory node and designating the third shared memory node as failed.

19. The method of claim 13, further comprising:
if an error is recognized in the third shared memory node, attempting to copy events occurring in the primary shared memory node to the third shared memory node.

20. The method of claim 14, further comprising:
if an error is recognized in the fourth shared memory node, writing a FAILED code to the fourth shared memory node and designating the fourth shared memory node as failed.

21. The method of claim 14, further comprising:
if an error is recognized in the third shared memory node, attempting to copy events occurring in the primary shared memory node to the fourth shared memory node.

22. The method of claim 18, further comprising:
if an error is recognized in the third shared memory node, switching backup of the secondary shared memory node to a fourth shared memory node.

23. An apparatus, comprising:
a processing node;
a dual-port adapter coupled to the processing node;
a primary shared memory node coupled to the dual-port adapter; and
a secondary shared memory node coupled to the dual-port adapter.

24. The apparatus of claim 1, wherein the dual-port adapter includes a dual-port PCI adapter.

25. The apparatus of claim 23, wherein the processing node includes a device selected from the group consisting of microprocessors, programmable logic devices, and microcontrollers.

26. The apparatus of claim 23, wherein the primary shared memory node is accessible by a plurality of processing nodes.

27. The apparatus of claim 23, wherein the secondary shared memory node is accessible by a plurality of processing nodes.

28. The apparatus of claim 23, further comprising:
another processing node coupled to the primary shared memory node and the secondary shared memory node;
another dual-port adapter coupled to the another processing node;
another primary shared memory node coupled to the another dual-port adapter; and
another secondary shared memory node coupled to the another dual-port adapter.

29. The apparatus of claim 23, wherein the dual-port adapter includes a dual-port PCI adapter.

30. The apparatus of claim 23, wherein the dual-port adapter includes at least a logic control, a switching circuit, and a non-volatile memory.
